(19) United States
(12) Patent Application Publication
(10) Pub. No.: US 2007/0076245 A1
(43) Pub. Date: Apr. 5, 2007

(54) Information processing device, information processing system, and information processing method

(76) Inventors: Noriko Sugimoto, Hyogo (JP); Shogo Hamasaki, San Jose, CA (US); Soichiro Fujioka, Osaka (JP); Atsushi Saso, Kanagawa (JP)

Correspondence Address: WENDEROTH, LIND & PONACK L.L.P., 2033 K. STREET, NW, SUITE 800, WASHINGTON, DC, 20006, US

(21) Appl. No.: 10/581,323

(22) PCT Filed: Feb. 25, 2005
(86) PCT No.: PCT/JP05/03134

§ 371 Date: Jun. 1, 2006

(30) Foreign Application Priority Data
Mar. 25, 2004 (JP) 2004-088880

(51) Int. Cl. G06F 3/12

(52) U.S. Cl. 358/1.15; 358/1.16

(57) ABSTRACT

There is provided an information processing device for realizing interactive viewing in which a plurality of users thereof share an image, and an operation performed on the image by any user among the plurality of users is shown in real time on the image viewed by another user. A plurality of information processing devices (2) and (3) belonging to a same group respectively transmit, to a server (4), image information respectively stored in the devices (2) and (3). The server (4) collects and manages images transmitted from the plurality of information processing devices (2) and (3), and concurrently transmits, to the plurality of information processing devices (2) and (3), a shared image in accordance with an image operation requested from any of the information processing devices (2) and (3). The information processing devices (2) and (3) receive the shared image transmitted from the server (4), and display the shared image on the display sections (26) and (36), respectively.

### TECHNICAL FIELD

The present invention relates to an information processing device, an information processing system and an information processing method, and particularly relates to information processing devices allowing users to share image information, an information processing system including the information processing devices, and an information processing method executed by the information processing devices.

### BACKGROUND ART

In recent years, information processing devices (hereinafter, referred to as camera-equipped information processing devices) such as a cellular phone on which a digital camera is mounted, a PDA (Personal Digital Assistant) and a personal computer are in widespread use. Since a storage medium mounted on such devices has increased in capacity, the number of opportunities for users of such devices to take images by using such devices has also increased. While the camera-equipped information processing devices are becoming widely prevalent and the number of opportunities to take images by using such a device has increased, there has been an increasing desire among the users to share with their friends an image taken by using such a device.

Techniques have been introduced in order to satisfy such a desire from the users. For example, there is a technique in which a user sends an image the user has taken to another user via a telephone line so that both the users can share the image. Also, there is another technique which makes it possible to create, on a particular album server, an album which can be shared via a network by a plurality of remote information processing devices. Further, in a medical field, there is a technique in which a user sends an image to another user, and both the users share the image via a communication line while exchanging remarks on the image by using a telephone line.

### DISCLOSURE OF THE INVENTION

Problems to be Solved by the Invention

Recently, in addition to the aforementioned desire, there has been an increasing desire among the users to perform interactive viewing in which all users belonging to a same group can share, by using their own respective information processing devices, images owned by the respective users and an operation performed at any time on an image among the images (e.g., page flipping operation) by any of the users is shown in real time on the image displayed on the information processing devices of all the users while the users communicate with each other or making voice calls to each other by using their own respective devices. In other words, there has been an increasing desire for an interactive communication in which each user communicates his/her thought to another user by performing an operation on a shared image in addition to sending text and voice. If such interactive viewing is realized, for example, in the case where two groups are planning to have a meeting or go on a trip, leaders of the two groups can discuss some matters beforehand while viewing images owned by the respective leaders and performing operations thereon. This allows the leaders who are remote from each other to have a detailed prearrangement for, e.g., deciding a suitable venue of the meeting, arranging appropriate seating while considering a personality of each group member, or arranging a detailed itinerary while considering a personal preference of the each group member.

However, the aforementioned conventional techniques only disclose how to share an image among a plurality of users, and do not disclose how the users use a shared image while communicating with each other or making voice calls to each other with their own respective devices. In other words, there has been a problem that the conventional techniques cannot realize interactive viewing in which a plurality of users view images owned by the respective users, and each of the plurality of users freely performs operations on the images while all the users can view in real time the images resulting from the operations performed thereon.

Therefore, an object of the present invention is to provide an information processing device, information processing system and an information processing method which realize interactive viewing in which a plurality of users share an image, and an operation performed thereon by any of the plurality of users is shown in real time on the image viewed by another of the plurality of users.

Solution to the Problems

The present invention is directed to an information processing device capable of sharing an image with another information processing device belonging to a same group as that of the information processing device and to an information processing system comprising a plurality of information processing devices and a server. In order to achieve the above object, the information processing device of the present invention includes an image storage section, a transmission section, an information retention section, a reception section, a display section, an operation instruction section and a control section. The server of the present invention includes a server reception section, a server image storage section, an information management section, a server control section and a server transmission section.

In the information processing device, the image storage section stores image information. The transmission section transmits to the server a whole or a part of the image information stored in the image storage section. The information retention section retains information concerning the group which the information processing device belongs to. The reception section receives, from the server, shared image information concerning image information to be shared by all information processing devices belonging to the same group which the information processing device belongs to, the image information to be shared having been specified by the server based on the whole or the part of the image information. The display section displays an image in accordance with the shared image information received by the reception section. The operation instruction section provides the server with an instruction in accordance with an operation performed by a user on the image displayed on the display section.

In the server, the server reception section receives image information from at least one of the plurality of information processing devices; the server image storage section stores the image information received by the server reception section; the information management section manages information concerning the plurality of information processing devices belonging to the same group; the server control section specifies, in accordance with the operation performed by the user and based on the image information stored in the server image storage section, image information to be shared by the plurality of information processing devices; and the server transmission section transmits, to the plurality of information processing devices, the shared image information concerning the image information which has been specified by the server control section.

In this system configuration, the control section of each of the plurality of information processing devices executes interactive image viewing with another of the plurality of information processing devices belonging to the same group by using the shared image information which is specified by the server at any time in accordance with an operation performed by any of the users of the plurality of information processing devices belonging to the same group, the shared image information being received by the reception section of each of the plurality of information processing devices.

The information retention section of the information processing device retains information managed by the information management section of the server, the information concerning a sub group set up by two or more information processing devices among the plurality of information processing devices belonging to the same group, and the control section of the information processing device is capable of executing interactive image viewing only within the sub group. In this case, the information processing device may further include a direct communication section for directly transmitting to at least one information processing device belonging to the sub group, without involving the server, an image to be shared only within the sub group.

The information processing device may further comprise an input section for inputting a feeling of the user about an image displayed on the display section, and the transmission section of the information processing device is capable of transmitting, to another information processing device belonging to the same group, feeling information corresponding to the feeling inputted into the input section. The information processing device may further comprise a direct communication section for directly transmitting, without involving the server, the feeling information to at least one information processing device belonging to the sub group.

Typically, the reception section downloads the shared image information in accordance with URL information notified from the server, the URL information indicating where the shared image information is stored. In the case where the information processing devices belonging to the same group are cellular phones, the URL information may be created based on phone numbers of all the information processing devices.

The operation instruction section is preferably a touch panel. If the operation instruction section is a touch panel, the operation instruction section is provided over the display section, and the control section is capable of displaying, on the display section, a shared image and a menu image for performing an operation on the shared image. The operation instruction section allows the user to perform an operation on the shared image by moving a finger of the user on the operation instruction section.

Preferably, the information processing device further comprises an image input section for inputting image information. It is desired that the image input section inputs image information together with attribute information indicating a time when the image information has been inputted, and causes the image storage section to store the image information and the attribute information. This allows the transmission section to transmit, to the server, the image information together with the attribute information.

Processes respectively performed by the image storage section, transmission section, reception section, display section and the operation instruction section of the above-described information processing device are considered as the information processing method comprising a series of procedures. In other words, in the information processing method: the whole or the part of the image information stored in the image storage section is transmitted to the server; the shared image information concerning image information to be shared by all the information processing devices belonging to the same group is received from the server, the image information to be shared having been specified by the server based on the whole or the part of the image information; an image is displayed in accordance with the shared image information received; an instruction is provided to the server in accordance with an operation performed by a user on the image displayed; the shared image information is rereceived, the shared image information being specified at any time by the server in accordance with the operation performed by the user; and the image is updated and displayed in accordance with the shared image information rereceived. Preferably, the information processing method is provided as a program for causing the information processing device to perform the series of procedures.

Effect of the Invention

As described above, according to the present invention, a plurality of information processing devices forming one group can share an operation performed on an image by any of the plurality of the information processing devices. This allows real-time interactive viewing among a plurality of users of the information processing devices. By forming a sub group within the group, a particular image can be shared, within the sub group, only among information processing devices mutually authenticating each other. This realizes image sharing having a high security level.

Since the server secures, in the image storage section, a shared area on which a shared image is written only when a request is received from the information processing device, a capacity of the image storage section can be saved. Since the information processing device is allowed to access only the shared area, a risk for, e.g., a falsification of data stored in a different area of the image storage section of the server, is lowered. Since the server deletes the shared area when image sharing by the information processing devices is completed, a wrongful access to the image attempted by a third party after the completion of the image sharing can be prevented, and thus a security level of the system is increased. Passwords issued to the respective information processing devices for the access to the shared area are created based on phone numbers of the respective information processing devices. This provides each of the users of the information processing devices with a convenience of having a password which is easy to remember, and also improves manageability of the passwords since a password duplication is prevented.

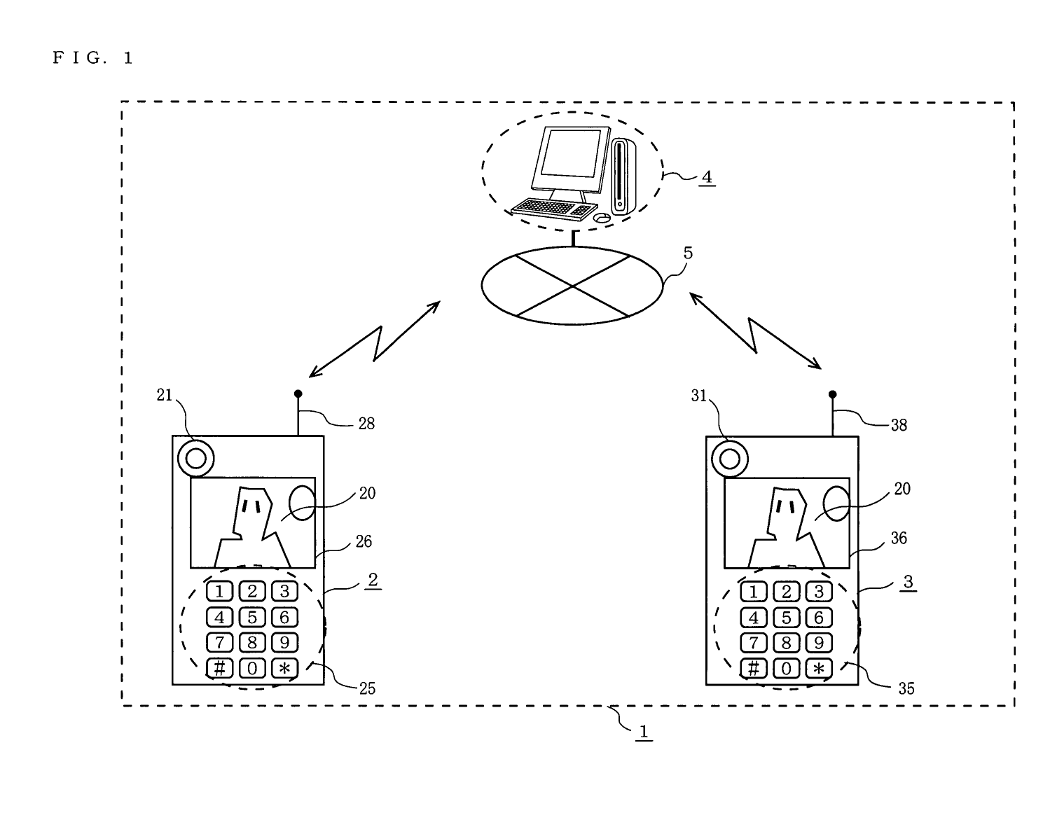

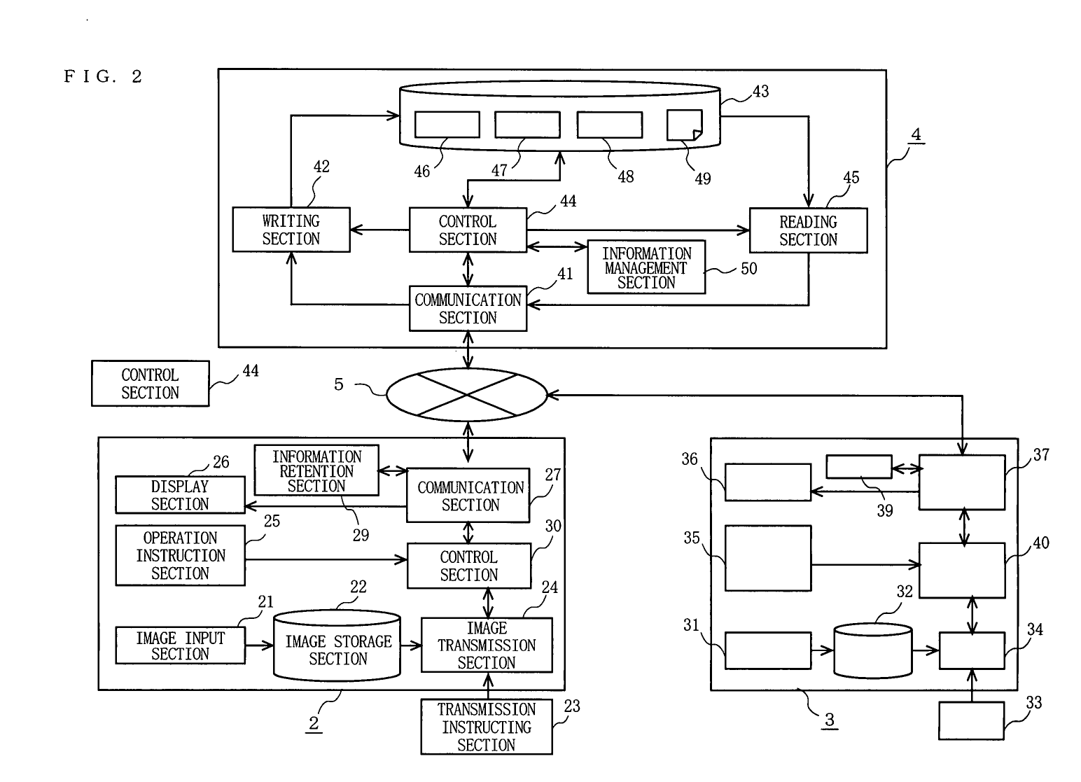

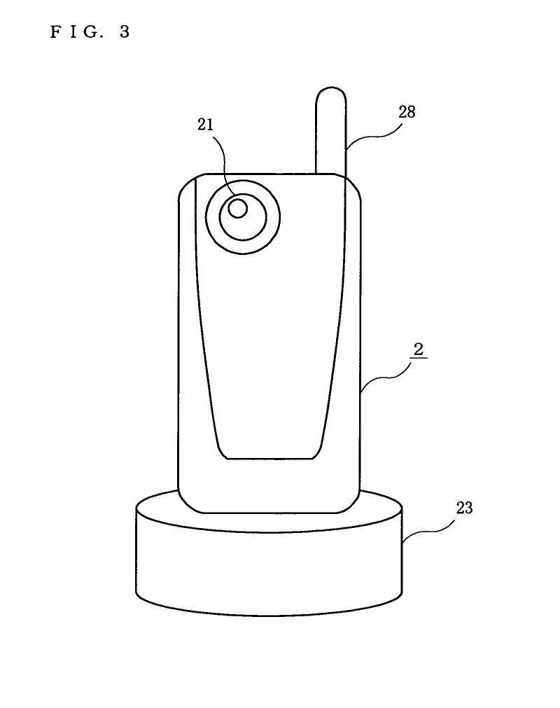

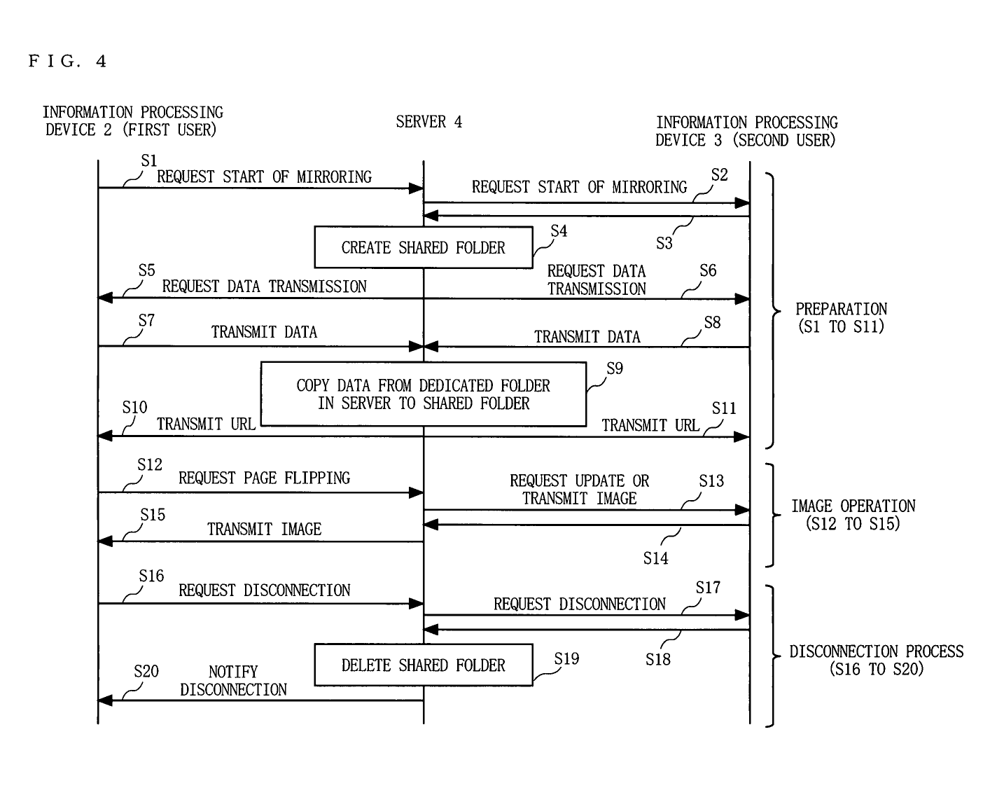

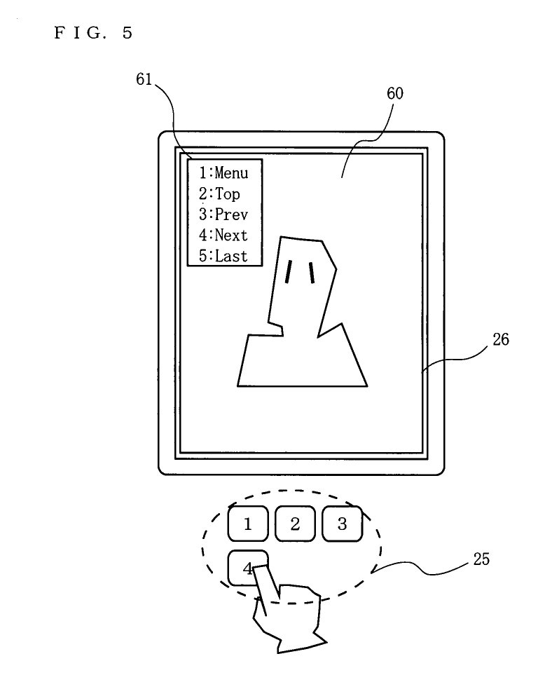

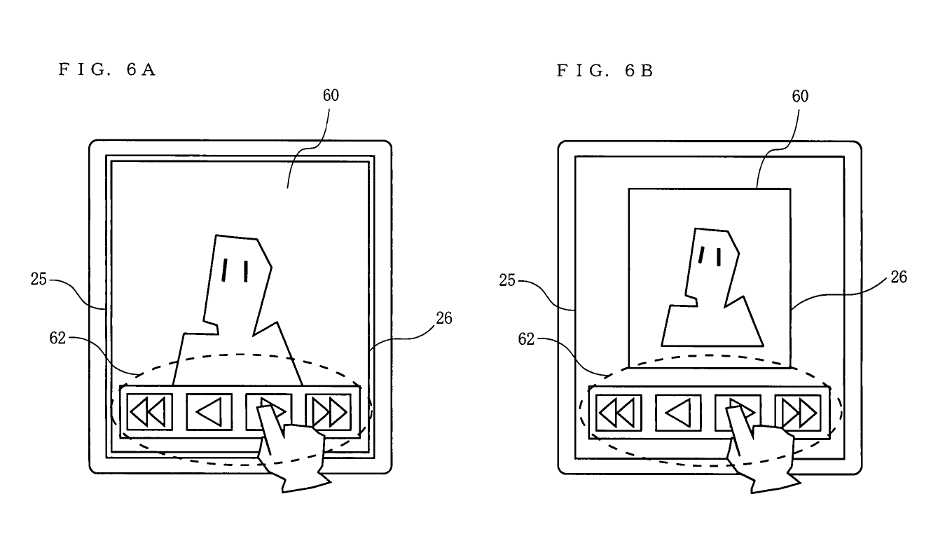

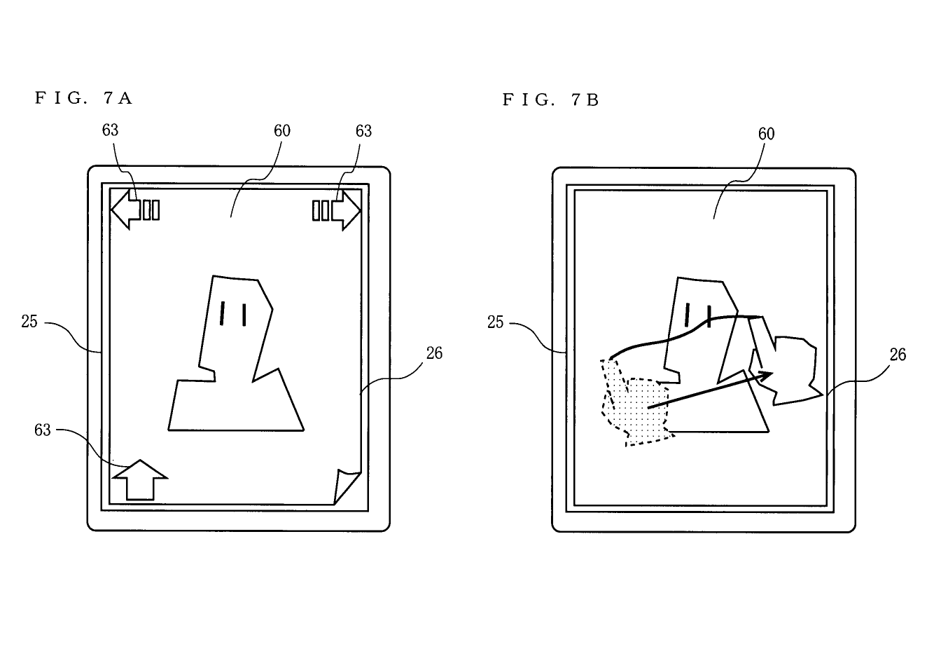

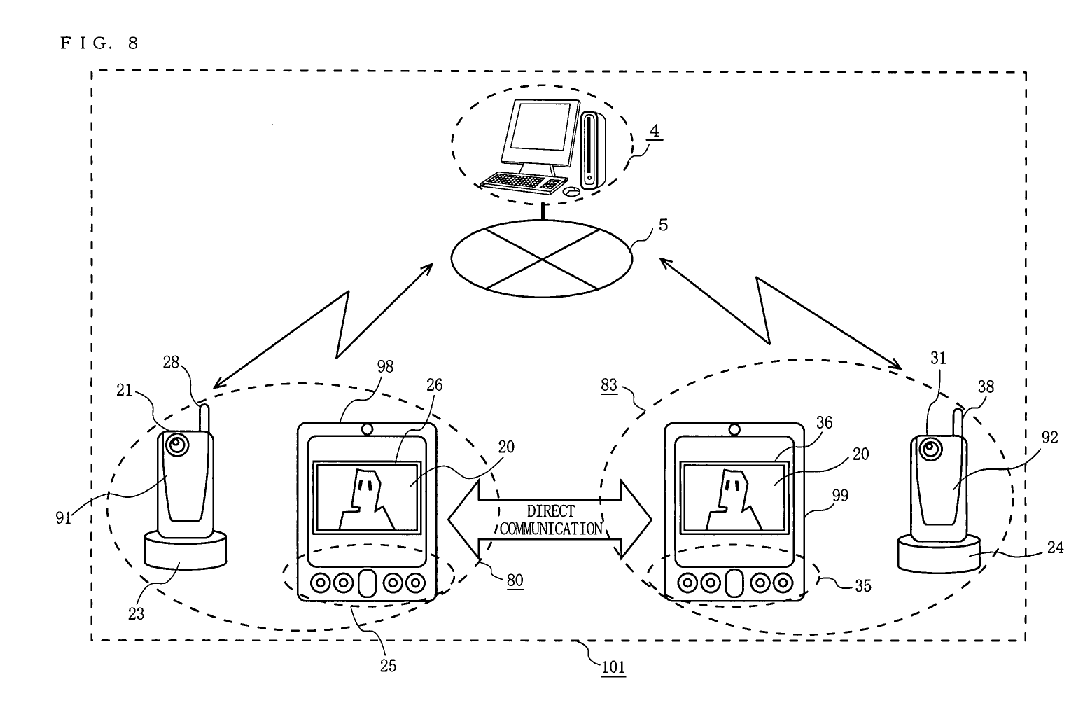

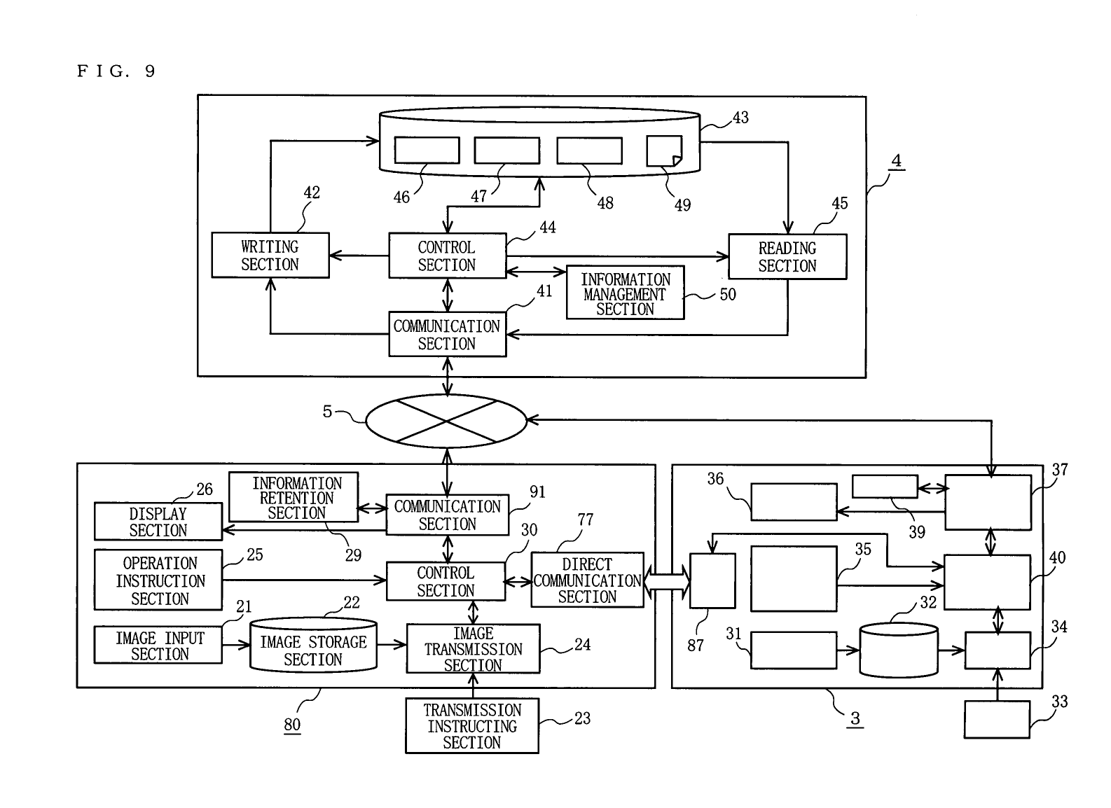

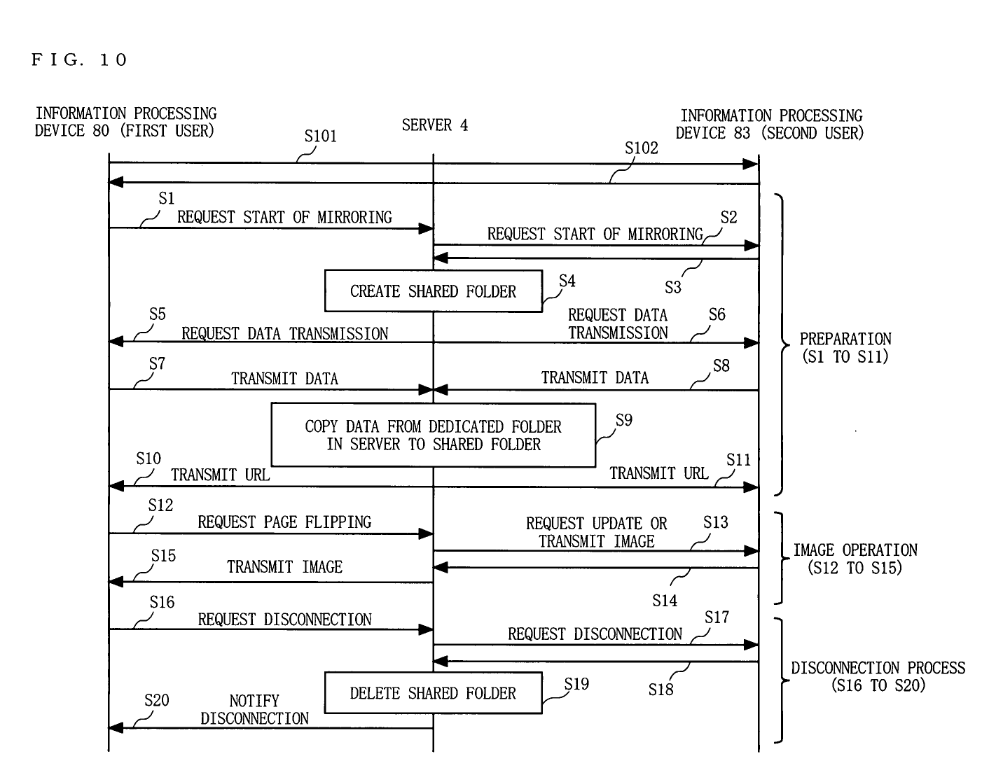

### BRIEF DESCRIPTION OF THE DRAWINGS

[FIG. 1] briefly illustrates an information processing system 1 according to a first embodiment of the present invention.

[FIG. 2] is a block diagram showing detailed structures of a server 4 and information processing devices 2 and 3 shown in FIG. 1.

[FIG. 3] shows an example of a transmission instructing section 23 shown in FIG. 2.

[FIG. 4] is a sequence diagram illustrating operations of the information processing system 1 according to the first embodiment of the present invention.

[FIG. 5] shows an exemplary image displayed at the start of mirroring on a display section 26 shown in FIG. 2.

[FIG. 6A] shows an exemplary image displayed at the start of mirroring on a display section 26 shown in FIG. 2.

[FIG. 6B] shows an exemplary image displayed at the start of mirroring on a display section 26 shown in FIG. 2.

[FIG. 7A] shows an exemplary image displayed at the start of mirroring on a display section 26 shown in FIG. 2.

[FIG. 7B] shows an exemplary image displayed at the start of mirroring on a display section 26 shown in FIG. 2.

[FIG. 8] briefly illustrates an information processing system 101 according to a second embodiment of the present invention.

[FIG. 9] is a block diagram showing detailed structures of the server 4 and information processing devices 80 and 83 shown in FIG. 8.

[FIG. 10] is a sequence diagram illustrating operations of the information processing system 101 according to the second embodiment of the present invention.

### DESCRIPTION OF THE REFERENCE CHARACTERS

1, 101 information processing systems
2, 3, 80, 83 information processing devices
4 server
5 network
20 image
21, 31 image input sections
22, 32, 43 image storage sections
23, 33 transmission instructing sections
24, 34 image transmission sections
25, 35 operation instruction sections
26, 36 display sections
27, 37, 41 communication sections
28, 38 antenna sections
29, 39 information retention sections
30, 40, 44 control sections
42 writing section
45 reading section
46, 48 dedicated folders
47 shared folder
49 grouping table
50 information management section
61 to 63 menu images
77, 87 direct communication sections
91, 92 communication devices
98, 99 viewer devices

### BEST MODE FOR CARRYING OUT THE INVENTION

Hereinafter, embodiments of the present invention will be described in detail with reference to drawings.

(First Embodiment)

FIG. 1 briefly illustrates an information processing system according to a first embodiment of the present invention. In FIG. 1, an information processing system 1 according to the first embodiment has a configuration in which information processing devices 2 and 3 are connected to a server 4 via a network 5. The information processing device 2 comprises: an image input section 21 for inputting an image taken by, e.g., a camera; a display section 26 for displaying the image; an operation instruction section 25 for giving instructions on various operations to be performed on the image displayed on the display section 26; and an antenna section 28 for performing communications with the server 4 via the network 5. The information processing device 3 comprises: an image input section 31 for inputting an image taken by, e.g., a camera; a display section 36 for displaying the image; an operation instruction section 35 for giving instructions on various operations to be performed on the image displayed on the display section 36; and an antenna section 38 for performing communications with the server 4 via the network 5. The information processing devices 2 and 3 belong to a same group. The network 5 is a well-known wired or wireless network, such as the Internet.

As will be described in detail below, in the information processing system 1 according to the first embodiment, a same image provided from the server 4 is displayed on the display section 26 of the information processing device 2 and the display section 36 of the information processing device 3, the devices 2 and 3 belonging to the same group. When a user of the information processing device 2 (hereinafter, referred to as a first user) performs any operation on an image 20 by using the operation instruction section 25, the operation is recognized by the server 4, and an image resulting from the operation is displayed on the display section 36 of the information processing device 3. Accordingly, a user of the information processing device 3 (hereinafter, referred to as a second user) can view in real time the operation performed on the image 20 by the first user. Since an image resulting from an operation performed on the image 20 by the second user using the operation instruction section 35 is also displayed on the display section 26 of the information processing device 2, the first user can also recognize in real time the operation performed on the image 20 by the second user.

Here, in the present invention, the “operation” which is performed on an image includes the following operations. For example, operations performed on a still image are, e.g., a “page flipping operation” for viewing a next or previous image of the image a user is currently viewing, a “jump operation” for viewing a first or last image, a “slide show operation” for displaying images consecutively by switching a displayed image at a predetermined time interval and for pausing the displaying, and a “write operation” for making a comment (including a text message, a voice memo and an onomatopoeic sound) and drawing a figure on the image. Operations which are performed on a moving image are, e.g., a “playback operation” for playing back, stopping, pausing, rewinding and fast forwarding the moving image and also for doing frame advance of the moving image, and the-aforementioned “write operation”.

The “operation” of the present invention may include operations performed for editing an image. Such operations are, for example, a “size changing operation” for enlarging or reducing the size of the image and also for deforming, inverting and rotating the image, an “image quality control operation” for changing the color or brightness of the image and an “arrangement operation” for changing an arrangement order of consecutive images and the number of images to be arranged.

Here, the onomatopoeic sound is a sound that a user causes the information processing device to generate in order to express a feeling of the user about an image which the user has viewed. For example, if the user has a positive feeling about the image such as “good” or “funny”, the user may use an onomatopoeic sound with a high frequency (e.g., “blip”), and if the user has a negative feeling about the image such as “bad” or “not so good”, the user may use an onomatopoeic sound with a low frequency (e.g., “boo-boo”). The user may cause the information processing device of the user to generate the onomatopoeic sound, or cause an information processing device of another user to generate the onomatopoeic sound. In the latter case, the user may transmit, to the information processing device of another user, e.g., sound data of the onomatopoeic sound or a command designating the onomatopoeic sound, as feeling information. Thus, the user can communicate a feeling of the user by transmitting to another user the feeling information as feedback.

Note that, although FIG. 1 shows an exemplary system configuration in which two information processing devices 2 and 3 are connected to the network 5, the number of information processing devices may be three or more. The three or more information processing devices may form one group or a plurality of groups. Here, an example has been described in which the information processing device 2 comprises the image input sections 21, and the information processing device 3 comprises the image input sections 31. However, if there is no need to take in an image from, e.g., a camera, the image input sections 21 and 31 are not essential components for the information processing devices 2 and 3.

Hereinafter, structures of the server 4 and the information processing devices 2 and 3 of the information processing system 1 according to the first embodiment of the present invention will be further described in detail. FIG. 2 is a block diagram showing detailed structures of the server 4 and the information processing devices 2 and 3 shown in FIG. 1. Since the information processing device 2 and the information processing device 3 are identical sharing a same structure except that tens places of reference numbers thereof are different, only the structure of the information processing device 2 will be described, and the structure of the information processing device 3 will not be further described below.

In FIG. 2, the server 4 comprises: a communication section 41 for transmitting and receiving information to and from the information processing devices 2 and 3 via the network 5; an image storage section 43 for storing image information; a writing section 42 for writing, in the image storage section 43, image information received by the communication section 41; a reading section 45 for reading information from the image storage section 43 and transmitting the information to the communication section 41 in response to a request received by the communication section 41; an information management section 50 for managing group information concerning a plurality of information processing devices belonging to a same group; and a control section 44 for controlling the writing section 42 and the reading section 45 in accordance with an operation instruction received by the communication section 41 and for specifying, among images stored in the image storage section 43, an image to be shared. Note that, the communication section 41 may be separated into a transmission section and a reception section.

The image storage section 43 includes a grouping table 49 for storing information which is used to specify a user who shares an image, and a dedicated folder which is prepared in advance with respect to each of users of information processing devices. In the grouping table 49, a main group for specifying all users who belong to a same group may be set, and also a sub group for specifying some users who belong to the same group may be set. In an example of FIG. 2, a first dedicated folder 46 for a first user and a second dedicated folder 48 for a second user are provided. A group is set up by the control section 44 in accordance with the group information managed by the information management section 50.

The information processing device 2 comprises: a communication section 27 for transmitting and receiving information to and from the server 4 via the network 5; an image input section 21; an image storage section 22 for storing an image inputted from the image input section 21; an image transmission section 24 for transmitting, to the communication section 27, a predetermined image among the images stored in the image storage section 22; a display section 26 for displaying an image received by the communication section 27; an information retention section 29 for retaining group information received by the communication section 27; a control section 30 for mediating a process performed between each component and controlling overall image viewing executed by the information processing device 2; and an operation instruction section 25. As described above, the image input section 21 is not an essential component of the information processing device 2. In the case where the information processing device 2 acquires an image only from the information processing device 3 or takes in image information from an external storage medium such as a semiconductor memory card, the image storage section 22 is also not an essential component.

Communication means which is capable of, e.g., making a voice call to the information processing device 3 and performing data communications with the server 4 at the same time, is used as the communication section 27. The voice call between the communication section 27 and the information processing device 3 is not necessarily performed via the server 4. The voice call may be performed via another server specially provided for making a voice call, or may be performed by using an IP phone. A device such as a photographic device or a scanner device using a CCD or a CMOS sensor that is usually mounted in a digital camera is used as the image input section 21. Considering portability, it is desired that a semiconductor memory be used as the image storage section 22. However, various types of storage medium such as an HDD and a DVD may be used as the image storage section 22. It is desired that an image inputted from the image input section 21 is stored in the image storage section 22 together with meta-information, e.g., date and time, when the image is taken or stored. Such meta-information may be automatically inputted from the image input section 21 when the image is inputted, or may be manually inputted by a user.

A display device such as an LCD or an EL for displaying an image is used as the display section 26. An operation-input device, for example, direct keys such as numeric keys, a touch panel, a joy stick or a slide lever is used as the operation instruction section 25. If, on the surface of the display section 26, a transparent touch panel is provided as the operation instruction section 25, various operations can be performed by using the operation instruction section 25 (described later).

The information processing device 2 may have a structure to which a transmission instructing section 23 can be externally connected, the transmission instructing section 23 for instructing the image transmission section 24 to transmit the image stored in the image storage section 22. A device such as a cradle may be used as the transmission instructing section 23. In the case where a cradle is used as the transmission instructing section 23, a user can instruct the image transmission section 24 to transmit the image stored in the image storage section 22, by, for example, connecting the information processing device 2 to the cradle, thereby providing (refer to FIG. 3) an electrical connection to a terminal and a switch (not shown in a figure) of the device 2.

Note that, if the information processing device 2 has a structure which does not include the transmission instructing section 23, an instruction is given to the image transmission section 24 in accordance with an input from the operation instruction section 25.

Next, operations of the information processing system 1 according to the first embodiment of the present invention are described. FIG. 4 is a sequence diagram describing the operations of the information processing system 1 according to the first embodiment of the present invention. For the description below, it is assumed that the first and second users are friends or lovers currently making a voice call therebetween by using the information processing devices 2 and 3, and the first and second users are exchanging the latest news about themselves while viewing images respectively taken by the first and second users.

When the first user connects the information processing device 2 to the transmission instructing section 23 which is a cradle, a signal that indicates a request for sharing an image and an operation performed thereon (hereinafter, referred to as mirroring) is transmitted (S1), via the communication section 27 and the network 5, from the image transmission section 24 of the information processing device 2 to the communication section 41 of the server 4.

In the server 4, the signal, which indicates the request for mirroring, is transmitted from the communication section 41 to the control section 44. The control section 44 refers to the grouping table 49 stored in advance in the image storage section 43, and selects a user who performs mirroring with the first user, i.e., the second user. The control section 44 notifies the information processing device 3 of the second user that there is the request from the first user for mirroring (S2). Considering practicality, it is desired at this point that a message, e.g., “You are receiving a request for mirroring from the first user. If it is OK to accept the request, press 1. If it is not OK to accept the request, press 0. ” is displayed on the display section 36 of the information processing device 3, or such a message may be outputted as a voice message.

When the second user is notified about the request for mirroring from the first user, the second user responds to the request (S3). In an example shown in FIG. 4, the second user makes a response accepting the request for mirroring. Such a response may be transmitted by performing a predetermined input (i.e., “press 1” in the above example) using the operation instruction section 35, or may be transmitted by connecting the information processing device 3 to the transmission instructing section 33, i.e., the cradle. Considering practicality, it is desirable to use the latter manner which is more user friendly. If the information processing device 3 has already been connected to the cradle, the second user is required to perform the above-described key input. The response accepting the request for mirroring may be automatically transmitted without requiring any key input. For example, the request for mirroring (S1) and the response thereto (S3) may be automatically transmitted at a designated time, and mirroring may be automatically begun between the information processing devices 2 and 3.

When the second user makes a response not accepting the request for mirroring (i.e., “press 0” in the above example), or the second user does not respond to the request for a predetermined period of time, the response indicating that the request cannot be accepted is transmitted from the control section 44 of the server 4 to the information processing device 2, and then a preparation process for mirroring is terminated (S3).

The control section 44 of the server 4 receives, from the information processing device 3, the response accepting the request for mirroring, and performs a process for specifying an image to be shared by the first and second users. The process is typically performed as described below.

First, the control section 44 creates, in the image storage section 43, a shared folder 47 for storing an image to be shared by the first and second users (S4). Next, the control section 44 transmits, to the information processing device 2, a request for a transmission of image information stored in the image storage section 22, and the control section 44 also transmits, to the information processing device 3, a request for a transmission of image information stored in the image storage section 32 (S5 and S6).

Upon receiving from the server 4 the request for the transmission of the image information, the image transmission section 24 of the information processing device 2 transmits to the server 4 the whole image information stored in the image storage section 22 or a part of the image information, the part of the image information having been prepared in advance for mirroring (S7). Similarly, upon receiving from the server 4 the request for the transmission of the image information, the image transmission section 34 of the information processing device 3 transmits to the server 4 the whole image information stored in the image storage section 32 or a part of the image information, the part of the image information having been prepared in advance for mirroring (S8). Note that, an image to be provided for mirroring can be specified by setting, in a predetermined folder or a table, an address that indicates image information of the image, a file name of the image and where the file is stored. In the case where meta-information of the image information is stored in the image storage section, the image information containing the meta-information is transmitted to the server 4.

The control section 44 of the server 4 instructs the writing section 42 to write, in the first dedicated folder 46 of the image storage section 43, the image information transmitted from the information processing device 2, and also instructs the writing section 42 to write, in the second dedicated folder 48 of the image storage section 43, the image information transmitted from the information processing device 3.

In the case where the image information from the information processing device 2 has already been stored in the first dedicated folder 46, or the image information from the information processing device 3 has already been stored in the second dedicated folder 48, a time required for a mirroring process can be shortened by causing the control section 44 to instruct the writing section 42 to only write, excepting the image information having already been stored in the dedicated folder, image information which has been newly read from the information processing devices, i.e., image information to be newly added to the dedicated folders.

When pieces of image information have been respectively stored into the first and second dedicated folders 46 and 48, the control section 44 copies, from the first and second dedicated folders 46 and 48 to the shared folder 47, a whole or a part of each of the pieces of image information (S9). At this point, if pieces of meta-information are respectively attached to the pieces of image information, the pieces of image information may be arranged in a chronological order according to, e.g., a date and a time when each of images has been taken, the images respectively corresponding to the pieces of image information. When only the part of each of the pieces of image information is to be copied, a storage capacity of the shared folder 47 can be reduced. However, in this case, every time a user performs an after-mentioned operation on an image, a piece of image information of the image on which the operation is performed is required to be copied to the shared folder 47 from the first dedicated folder 46 or the second dedicated folder 48. Instead of copying the piece of image information, a piece of pointer information may be written on the shared folder 47, the piece of pointer information indicating a storage address of the piece of image information in the first dedicated folder 46 or the second dedicated folder 48.

Next, the control section 44 transmits, to the information processing devices 2 and 3, URL (Uniform Resource Locator) information contained in the image information having been copied to the shared folder 47, the URL information indicating an address of image information to be first shared (S10 and S11). The image information to be first shared is, for example, image information of an image which has been taken most recently (or earliest taken one). Here, if the URL information transmitted from the server 4 is displayed as a hyperlink on the display section 26 of the information processing device 2 and the display section 36 of the information processing device 3, each of the first and second users can easily access specific image information stored in the shared folder 47 by clicking on the displayed URL information. Further, by disclosing the URL information to a third person other than the first and second users, an image on which an operation has been performed can be published to the third person.

Although the third person cannot perform an operation on the image, the third person who has obtained the URL information can, e.g., observe in real time, by accessing the URL, operations performed by the first and second users on the image shared by the two users. Further, by using the URL information, the third person may provide a service for recording, on a medium such as a CD or a DVD, image information which is obtained as a result of operations performed on an image by the first and second users. This corresponds to a case where the first and second users form a sub group, and the first user, second user and third person form a main group.

Such a publish function of the image is useful especially when representative persons of the above-mentioned two groups show images to each other in order to make a particular decision before having a meeting. By publishing to participants of the meeting an image on which the decision made by the representative persons of the two groups is shown, the participants can obtain detailed information about the meeting before having the meeting.

If pieces of URL information for specifying the respective information processing devices 2 and 3 which perform mirroring therebetween are created by using respective telephone numbers of the devices 2 and 3, a possibility of overlapping URL information is reduced, and also a practical system configuration is realized. For example, it is assumed that the telephone number of the information processing device 2 is “001-111-1111”, the telephone number of the information processing device 3 is “002-222-2222”, a URL of the server 4 is “http://www.Panasonic.com”, and a file name of the shared image is “file1.jpg”. In this case, URL information specifying a shared image in the shared folder 47 may be set, by combining the above pieces of information, as “http://www.Panasonic.com/00111111110022222222/file1.jpg”.

A preparation for mirroring between the information processing devices 2 and 3 is completed by the above process. Even in the middle of the preparation for mirroring, making a voice call between the information processing devices 2 and 3 is possible. This allows the first and second users to wait for the preparation for mirroring to be completed without getting bored.

In order to start mirroring, the first user selects URL information of the shared folder 47 which is displayed on the display section 26 of the information processing device 2, and the second user selects the URL information of the shared folder 47 which is displayed on the display section 36 of the information processing device 3. As a result, shared image information stored in the shared folder 47 is transmitted from the reading section 45 to the information processing devices 2 and 3 via the communication section 41. Thus, each of the first and second users can view, at the same time, a same image corresponding to the shared image information.

At the start of mirroring, such an image as shown in FIG. 5, 6 or 7 may be displayed on the display section 26 of the information processing device 2 and the display section 36 of the information processing device 3.

FIG. 5 shows an example in which, a menu image 61 for prompting an operation on an image is displayed on the display section 26 together with a predetermined image 60 stored in the shared folder 47. The menu image 61 shows, in the case where direct keys are used as the operation instruction section 25, options of operation to be performed on the image 60, the options respectively corresponding to the direct keys. In the example of FIG. 5, an option “Menu” for displaying the menu image is allocated to a key “1”, “Top” for displaying an initial image is allocated to “2”, “Prev” for displaying a previous image is allocated to “3”, “Next” for displaying a next image is allocated to “4”, and “Last” for displaying a last image is allocated to “5”. Considering practicality, it is desired to display such an image as a menu image 61 that allows the user to easily recognize which kind of operation the user can perform, by pressing each key, on the image 60 the user is currently viewing.

FIGS. 6A and 6B show examples in which the menu image 62 is displayed on the display section 26, the menu image 62 being for prompting the user to perform, by using a transparent touch panel as the operation instruction section 25, an operation on the image. FIG. 6A is an example showing that the menu image 62 is displayed over the image 60 displayed on the display section 26. FIG. 6B is an example showing that the menu image 62 is displayed on an area of the display section 26, the area being separated from another area of the display section 26 on which the image 60 is displayed. When the user touches an icon displaying part of the menu image 62 displayed on the display section 26, an operation whose icon is displayed on a position touched by the user is selected, and then the user can perform the operation on the image. In examples shown in FIGS. 6A and 6B, a finger of the user is touching a rightward arrow to give an operation instruction “move one page forward”. Since a technique concerning a touch panel is well known, a description thereof will not be described here. As described above, by providing the operation instruction section 25 in an area such as where the menu image 62 is displayed (a lower part of the image 60 of FIG. 6A or an area which is below the image 60 of FIG. 6B), a higher visibility is obtained compared with the case where the transparent touch panel having a high reflectivity is formed on an entirety of the display section 26.

Similarly to FIGS. 6A and 6B, FIG. 7A shows another example in which a transparent touch panel is used as the operation instruction section 25 and menu images 62 for prompting the user to perform an operation on the image are displayed on the display section 26. The menu images 63 are arrow-shaped icons which are only displayed at a particular time (e.g., when a predetermined time has passed after the image is displayed, or when the user presses a particular key). As shown in FIG. 7B, the user can perform the page flipping operation on the image 60 displayed on the display section 26, by sliding, while viewing the menu image 63, a finger on the touch panel to a direction indicated by an arrow, i.e., to the right. By displaying such images as the menu images 63, the user can intuitively perform an operation on an image.

Here, it is assumed that the first and second users have finished a conversation about the image 60 displayed on the display section 26, and the first user has pressed a key “4” of the operation instruction section 25 in order to switch the image 60 (i.e., in order to perform the page flipping operation), which is currently displayed on the display section 26, to a next image (S12). When the key is pressed, an instruction to “flip the page” is given to the control section 44 of the server 4. Then, the control section 44 and the reading section 45 read from the shared folder 47 an image which is stored next to the image 60, and transmits the image to the information processing devices 2 and 3 (S15 and S13). The transmitted image is displayed on the display section 26 of the information processing device 2 and the display section 36 of the information processing device 3.

By performing the above-described procedures (S12 to S15), the image, which is obtained as a result of the “page flipping operation” performed by the first user using the information processing device 2, can be displayed on the display section 36 of the information processing device 3 as well as on the display section 26 of the information processing device 2. This means that an image obtained as a result of the operation performed by the first user is also shown on the information processing device of another user, and all users belonging to a same group can view the image in real time as the operation is being performed thereon.

Note that, the system may be configured such that the menu image 61 is created in the control section 44 of the server 4 and transmitted, together with an image, to the information processing devices 2 and 3. Considering practicality, it is desired in such a system configuration that the control section 44 creates a different menu image 61 depending on, for example, capabilities of the information processing devices 2 and 3 such as a screen resolution of the devices and whether a touch panel is mounted on the devices, or depending on whether a content to be transmitted is a moving image or a still image, and then an appropriate menu image 61 is transmitted to the information processing devices 2 and 3.

In the above embodiment, it has been described that the image 60 on which the operation has been performed is directly transmitted from the server 4 to the information processing device 3 (S13). However, instead of transmitting the image 60, a signal may be transmitted from the control section 44 to the information processing device 3, the signal indicating that the image displayed on the display section 36 should be updated. In this manner, the signal indicating that the image displayed on the display section 36 is going to be updated is transmitted from the information processing device 3 to the server 4 (S14), and then the user can view by using the information processing device 3 the image 60 on which the operation has been performed. The same applies to step S15. A timing of requesting an update of the image may not be limited to immediately after an operation has been performed on the image by the information processing device 2. For example, such a request for the update may be automatically transmitted at regular time intervals, or the request for the update may be transmitted when the second user makes the request. The latter manner allows the second user to view operations performed on the image by the first user at the second user's own pace which is different from a pace of the operations performed by the first user.

Note that, by keeping the voice call between the information processing devices 2 and 3 from a point when an operation is performed on an image (S12) to a point when an image resulting from the operation is read (S15), the first and second users can talk to each other while performing the operation on the image in the shared folder 47, and share a result of the operation. Thus, the first and second users can talk to each other and exchange the latest news about themselves while performing operations on the shared image.

Next, a disconnection process of mirroring is described. When the conversation between the users is over, either user, e.g., the first user from the above example, makes a request for a disconnection of the mirroring via the operation instruction section 25 of the information processing device 2 (S16). Upon receiving the request for the disconnection of the mirroring from the information processing device 2, the control section 44 of the server 4 checks with the information processing device 3 if the disconnection of the mirroring can be agreed (S17). Considering practicality, it is desired at this point that a text message, e.g., “Is it OK to disconnect the mirroring? If it is OK, press 1. If it is not OK, press 0.” is displayed on the display section 36 of the information processing device 3, or such a message may be outputted as a voice message. The second user transmits to the control section 44 of the server 4, a signal indicating that the second user is going to disconnect the mirroring, by operating the operation instruction section 35 of the information processing device 3 (in the above example, press “1”), or disconnecting the voice call, or removing the information processing device 3 from the cradle (S18). Note that, when the voice call is disconnected, the voice call is also disconnected at the same time.

Upon receiving from the information processing device 3 the signal indicating that the second user is going to disconnect the mirroring, the control section 44 of the server 4 deletes the shared folder 47 which is stored in the image storage section 43 (S19). Wastage of a storage capacity of the image storage section 43 is prevented, by creating (S4) the shared folder 47 every time the mirroring process is begun and deleting (S19) the shared folder 47 every time the mirroring process is terminated. This increases a security level of the system since there is no danger of the shared folder 47 to be viewed by a third party after the mirroring is disconnected. If the security level is required to be further increased, access to the shared folder 47 by a third party may be set restricted when the shared folder 47 is created (S4). For example, the security level is further increased if the control section 44 creates a one-time password for the mirroring process and transmits the password to the information processing devices 2 and 3, and by using the password, restricts access to the shared folder 47 by a third party while the mirroring process is performed. There is another exemplary manner for restricting the access, in which telephone numbers of the information processing devices 2 and 3 are used as encryption keys.

After the shared folder 47 is deleted (S19), the mirroring process can be terminated by transmitting, from the server 4 to the information processing device 2, a signal indicating that the mirroring process has been terminated (S20). Considering practicality, it is desired at this point that a message, e.g., “Mirroring has been terminated” is displayed on the display section 26 of the information processing device 2, or such a message may be outputted as a voice message.

It has been described in the above first embodiment that functions such as managing an image file stored in the image storage section 43 of the server 4 and performing an operation on the image file (e.g., creating and deleting the shared folder 47, creating URL information for specifying an image to be shared, and performing an operation on an shared image) are all performed by the control section 44. However, each of such functions may be performed by a separate circuit which is dedicated to each function. It is understood that the functions of the control section 44 may also be performed by software.

(Second Embodiment)

FIG. 8 briefly illustrates an information processing system according to a second embodiment of the present invention. In FIG. 8, an information processing system 101 according to the second embodiment has a configuration in which the information processing devices 80 and 83 are connected to the server 4 via the network 5. Note that, the number of information processing devices connected to the server 4 and a manner of forming a group by the information processing devices are the same as those described in the first embodiment.

FIG. 9 is a block diagram showing detailed structures of the server 4 and the information processing devices 80 and 83 shown in FIG. 8. The information processing device 80 comprises: a communication device 91 that includes a communication section for transmitting and receiving information to and from the server 4 via the network 5; the image input section 21; the image storage section 22; the image transmission section 24 for transmitting to the communication device 91 a predetermined image among images stored in the image storage section 22; the display section 26 for displaying an image received by the communication device 91; the information retention section 29; the control section 30; the operation instruction section 25; and a direct communication section 77 for performing direct communications with another information processing device. Needless to say, a detailed structure of the information processing device 83 is the same as that of the information processing device 80.

As is clear from FIGS. 8 and 9, the information processing system 101 according to the second embodiment has a different structure from that of the information processing system 1 according to the above first embodiment in that the information processing device 80 is divided into the communication device 91, which includes the image input section 21 and the antenna section 28, and a viewer device 98, which includes the display section 26 and the operation instruction section 25; the information processing device 83 is divided into a communication device 92, which includes the image input section 31 and the antenna section 38, and a viewer device 99, which includes the display section 36 and the operation instruction section 35; and the viewer devices 98 and 99 perform direct communications therebetween without involving the server 4. Note that, functions of component elements of the information processing system according to the second embodiment, which are denoted by same reference numerals as those used for the component elements of the information processing system according to the first embodiment, are same as those of the component elements of the information processing system according to the first embodiment. Therefore, these component elements of the information processing system according to the second embodiment will not be further described below.

Hereinafter, the information processing system 101 according to the second embodiment will be described with a focus on component elements which are different from those of the information processing system according to the first embodiment.

Similarly to the above first embodiment, in the information processing system 101 according to the second embodiment, the same image 20 provided from the server 4 is displayed on the display section 26 of the information processing device 80 and the display section 36 of the information processing device 83, the devices belonging to a same group. When a user of the information processing device 80 (hereinafter, referred to as a first user) performs any operation on the image 20 by using the operation instruction section 25, the operation is recognized by the server 4, and an image resulting from the operation is displayed on the display section 36 of the information processing device 83. Accordingly, a user of the information processing device 83 (hereinafter, referred to as a second user) can view in real time the operation performed on the image 20 by the first user. Since an image resulting from an operation performed on the image 20 by the second user using the operation instruction section 35 is also displayed on the display section 26 of the information processing device 80, the first user can also view in real time the operation performed on the image 20 by the second user.

Well-known communication means such as a cellular phone or a terminal device of a wireless LAN may be used as the communication device 91. Although FIG. 8 shows an example in which the image input section 21 is mounted on the communication device 91, the input section 21 may be mounted on the viewer device 98. It is desired that the image storage section 22 be mounted on the viewer device 98. Well-known means such as Bluetooth or IrDA which are capable of directly transmitting and receiving information to and from another information processing device may be used as the direct communication section 77.

Similarly to the first embodiment, the information processing device 80 may have a structure to which a transmission instructing section 23 (e.g., cradle) can be externally connected, the section 23 instructing the image transmission section 24 to transmit an image stored in the image storage section 22. The cradle may have a structure in which when the communication device 91 or the viewer device 98 is connected to the cradle, the cradle instructs the image transmission section 24 to transmit the image.

Next, operations of the information processing system 101 according to the second embodiment of the present invention will be described. FIG. 10 is a sequence diagram illustrating the operations of the information processing system 101 according to the second embodiment of the present invention. For the description below, it is assumed that at a meeting, the first and second users who are not acquainted with each other take seats close to each other, and share an image and an operation performed thereon by using their own respective information processing devices.

As shown in FIG. 10, process steps performed by the information processing system 101 according to the second embodiment of the present invention differ from process steps performed by the information processing system 1 according to the first embodiment in that a process described below is performed before a request for mirroring is transmitted (S1) from the information processing device 80 to the server 4. First, a signal indicating a request for mirroring and transmission of essential information is directly transmitted from the information processing device 80 to the information processing device 83 (S101) The information processing device 83 to which the request is to be transmitted is easily specified by using the group information retained in the information retention section 29. Thereafter, a signal indicating that the request for mirroring has been accepted and the essential information, e.g., an IP address of the information processing device 83, are transmitted from the information processing device 83 to the information processing device 80 (S102). This information transmitting process is required in order to enable the server 4 to later establish the connection with the information processing device 83.

The request from the information processing device 80 to the information processing device 83 for mirroring does not necessarily have to be transmitted by one-to-one communication. The request may be transmitted by one-to-n communication, i.e., a broadcast communication from the information processing device 80 to a plurality of information processing devices existing within a predetermined range (S101). In this case, upon receiving the request transmitted by the broadcast communication, the information processing device 83 makes a response accepting the request for mirroring, and transmits predetermined information to the information processing device 80 which has transmitted the request for the mirroring (S102).

By performing the above process, when the information processing device 80 later transmits a request for mirroring to the server 102, the device 80 can also transmit to the server 4 information concerning the information processing device 83 with which the device 80 performs the mirroring (S1). Accordingly, the control section 44 of the server 4 can store, in the grouping table 49 of the image storage section 43, the information, e.g., IP addresses of the information processing devices 80 and 83, as a piece of group information. Processes at steps S2 to S20 are same as those described in the above first embodiment.

As described above, by the information processing system 101 according to the second embodiment, users of the information processing devices who are not designated correspondents for each other can share images owned by the respective users, and each of the users can perform operations on the images. The users can view images resulting from the operations, by using their own respective information processing devices. This allows people, e.g., participants of a meeting, to share images, e.g., pieces of image data for a presentation, which are owned by the respective participants, and each of the participants can perform operations on the images.

Similarly to the first embodiment, according to the second embodiment, when users of the information processing devices have, for example, a group discussion, and one of the users, together with some other participants of the discussion, performs operations on an image material of the user for a presentation or creates an image material for the presentation, a resultant image material can be published, for the purpose of sharing the image material with a third person, to the third person also participating in the discussion, by disclosing (i.e., publishing), e.g., URL information, to an information processing device of the third person. In this case, it is possible to prevent a participant of the discussion to whom the image is published from performing an operation on the image. This prevents a wrongful act such as a falsification of a shared material.

Further, according to the second embodiment, a request for mirroring and a response thereto can be transmitted by direct communications between the information processing device 80 and the information processing device 83. Therefore, a possibility of masquerading is lower compared with, e.g., when mirroring is performed via a server, and thus a system configuration having a higher security level can be realized.

In the above first and second embodiments, exemplary system configurations have been described in which the server and the information processing devices are separately provided. However, a system that does not include the separately provided server may be configured, by incorporating a function of the server into any one of the information processing devices.

### INDUSTRIAL APPLICABILITY

The information processing devices, the information processing system and the information processing method of the present invention may be used when, for example, a plurality of users of the devices share an image. The information processing devices, the information processing system and the information processing method are useful particularly when, for example, an operation performed on a shared image by any of the users is desired to be shown in real time on the shared image viewed by another of the users.

1-19. (canceled)

20. An information processing device capable of sharing an image with another information processing device belonging to a same group as that of the information processing device, the information processing device comprising:
an image storage section operable to store image information;
a transmission section operable to transmit to a server a whole or a part of the image information stored in the image storage section;
an information retention section operable to retain information concerning the group which the information processing device belongs to and information concerning a sub group which is set up between the information processing device and at least one information processing device belonging to the same group as that of the information processing device;
a reception section operable to receive, from the server, shared image information concerning image information to be shared by all information processing devices belonging to the same group, the image information to be shared having been specified by the server based on the whole or the part of the image information;
a display section operable to display an image in accordance with the shared image information received by the reception section;
an operation instruction section operable to provide the server with an instruction in accordance with an operation performed by a user on the image displayed on the display section; and
a control section operable to execute interactive image viewing with another information processing device which belongs to the same group and with which the sub group is set up, by using the shared image information received by the reception section, the shared image information being specified by the server at any time in accordance with an operation performed by a user of any information processing device that belongs to the same group.

21. The information processing device according to claim 20, further comprising an input section operable to input a feeling of the user about an image displayed on the display section,
wherein the transmission section transmits, to another information processing device belonging to the same group, feeling information corresponding to the feeling inputted into the input section.

22. The information processing device according to claim 20, further comprising a direct communication section operable to directly transmit to at least one information processing device belonging to the sub group, without involving the server, an image to be shared only within the sub group.

23. The information processing device according claim 21, further comprising a direct communication section operable to directly transmit, without involving the server, the feeling information to at least one information processing device belonging to the sub group.

24. The information processing device according to claim 20 wherein the reception section downloads the shared image information in accordance with URL information which is notified from the server, the URL information indicating where the shared image information is stored.

25. The information processing device according to claim 24 wherein the URL information is created based on cellular phone numbers of all the information processing devices belonging to the same group.

26. The information processing device according to claim 20 wherein the operation instruction section is a touch panel.

27. The information processing device according to claim 26, wherein
the operation instruction section is provided on the display section; and
the control section causes the display section to display a shared image and a menu image with which a user performs an operation on the shared image.

28. The information processing device according to claim 26 wherein the operation instruction section allows the user to perform an operation on a shared image by moving the user's finger on the operation instruction section.

29. The information processing device according to claim 20, further comprising an image input section operable to input the image information.

30. The information processing device according to claim 29, wherein
the image input section inputs the image information and attribute information indicating a time when the image information has been inputted, and causes the image storage section to store the image information and the attribute information;
the transmission section transmits to the server the image information and the attribute information.

31. An information processing system allowing a plurality of information processing devices belonging to a same group to share an image via a server, wherein
each of the plurality of information processing devices comprises:
an image storage section operable to store image information;
a transmission section operable to transmit to the server a whole or a part of the image information stored in the image storage section;
an information retention section operable to retain information concerning the group which the information processing device belongs to and information managed by the server concerning a sub group set up between two or more information processing devices among the plurality of information processing devices belonging to the same group;
a reception section operable to receive shared image information from the server;
a display section operable to display an image in accordance with the shared image information received by the reception section;
an operation instruction section operable to provide the server with an instruction in accordance with an operation performed by a user on the image displayed on the display section; and
a control section operable to control image viewing by the device, the server comprises:
a server reception section operable to receive the image information from at least one of the plurality of information processing devices;
a server image storage section operable to store the image information received by the server reception section;
an information management section operable to manage information concerning the plurality of information processing devices belonging to the same group;
a server control section operable to specify, in accordance with the operation performed by the user and based on the image information stored in the server image storage section, image information to be shared by the plurality of information processing devices; and
a server transmission section operable to transmit, to the plurality of information processing devices, the shared image information concerning the image information which has been specified by the server control section,
the control sections of the information processing devices, between which the sub group is set up and which are among the plurality of information processing devices, execute interactive image viewing among the plurality of information processing devices by using the shared image information which is specified by the server at any time in accordance with the operation performed by the user, the shared image information being received by the reception section.

32. The information processing system according to claim 31 wherein the information processing device further comprises an input section operable to input a feeling of a user about an image displayed on the display section, and transmits by using the transmission section, to another information processing device belonging to the same group, feeling information corresponding to the feeling inputted into the input section.

33. The information processing system according to claim 31 wherein the information processing device belonging to the sub group further comprises a direct communication section operable to directly communicate with another information processing device without involving the server, and directly transmits, to another information processing device belonging to the sub group, an image to be shared only within the sub group.

34. The information processing system according to claim 32 wherein the information processing device belonging to the sub group further comprises a direct communication section operable to directly communicate with another information processing device without involving the server, and directly transmits, to another information processing device belonging to the sub group, the feeling information.

35. An information processing method executed by an information processing device capable of sharing an image with another information processing device belonging to a same group as that of the information processing device, the method comprising steps of:
transmitting to a server a whole or a part of image information stored in the image storage section;
receiving, from the server, shared image information concerning image information to be shared by all information processing devices belonging to the same group, the image information to be shared having been specified by the server based on the whole or the part of the image information;
displaying an image in accordance with the shared image information received at the receiving step;
providing the server with an instruction in accordance with an operation performed by a user on the image displayed at the displaying step;
rereceiving the shared image information which is specified at any time by the server in accordance with the operation performed by the user; and
updating and displaying the image in accordance with the shared image information received at the rereceiving step.

36. A computer-readable program for causing an information processing device to execute an information processing method for sharing an image with another information processing device belonging to a same group as that of the information processing device, the program comprising steps of:
transmitting to a server a whole or a part of image information stored in the image storage section;
receiving, from the server, shared image information concerning image information to be shared by all information processing devices belonging to the same group, the image information to be shared having been specified by the server based on the whole or the part of the image information;
displaying an image in accordance with the shared image information received at the receiving step;
providing the server with an instruction in accordance with an operation performed by a user on the image displayed at the displaying step;
rereceiving the shared image information which is specified at any time by the server in accordance with the operation performed by the user; and
updating and displaying the image in accordance with the shared image information received at the rereceiving step.

37. The information processing system according to claim 31 wherein when a transmission of the shared image information performed by the server transmission section has been completed or when interactive image viewing among the plurality of information processing devices has been completed, the server control section deletes image information by which the shared image information stored in the server image storage section has been specified.
